(19) United States
(12) Patent Application Publication
(10) Pub. No.: US 2013/0077201 A1
(43) Pub. Date: Mar. 28, 2013

(54) OVERVOLTAGE PROTECTION USING A LINK CURRENT SENSOR

(71) Applicant: John Duward Sagona, Poplar Grove, IL (US)

(72) Inventor: John Duward Sagona, Poplar Grove, IL (US)

(21) Appl. No.: 13/241,996

(22) Filed: Sep. 23, 2011

(51) Int. Cl. H02H 3/20

(52) U.S. Cl. 361/91.1

(57) ABSTRACT

An example overvoltage protection device includes a switch and a link current sensor that measures current through the switch. The overvoltage protection device is selectively activated by transitioning the switch between an off-state and an on-state. The switch is transitioned from the on-state to the off-state in response to a current measurement from the DC link current sensor. The current sensor is a DC link current sensor in one example.

### BACKGROUND

This disclosure relates to electrical power generation and, more particularly, to overvoltage protection in an electrical power generation system.

Electrical power generating systems are well known. Electrical power generating systems produce electrical energy for various loads. Some electrical power generating systems generate power using a generator. In aircraft electrical power generating systems, variable frequency generators are often used to supply power. Turbine engines drive the variable frequency generators.

Under some conditions, an electrical power generating system may experience an overvoltage (or voltage spike). The overvoltage can damage components powered by the electrical power generating system. Example conditions that may cause the overvoltage include suddenly removing a load or an arc fault. There are many strategies for limiting or containing overvoltages, but desirable overvoltage protection remains lacking.

In some designs, switches activate an overvoltage protection device for a predetermined amount of time. An overvoltage condition may occur if the overvoltage protection device is deactivated prematurely.

### SUMMARY

An example overvoltage protection device includes a switch and a current sensor that measures current through the switch. The overvoltage protection device is selectively activated by transitioning the switch between an off-state and an on-state. The switch is transitioned from the on-state to the off-state in response to a current measurement from the current sensor. The current sensor is a DC Link current sensor in one example.

An example electrical power system overvoltage protection arrangement includes a variable frequency generator that provides an AC voltage rectified through a rectifier to create a DC Link, which provides a DC voltage. An overvoltage protection device activates a switch and sends an Exciter Off signal to the generator control unit (GCU) to de excite the generator if the DC voltage exceeds a threshold value. The overvoltage protection device is configured to absorb the DC voltage in excess of the threshold value. A DC link current sensor measures current. The overvoltage protection device is deactivated in response to a current reading from the DC link current sensor.

An example method of accommodating an overvoltage includes sensing a voltage and selectively activating a switch and sending an Exciter Off signal to the GCU to de-excite the generator in response to the sensed voltage. The method selectively deactivates the overvoltage protection device in response to a current measurement.

### DESCRIPTION OF THE FIGURES

The various features and advantages of the disclosed examples will become apparent to those skilled in the art from the detailed description. The figures that accompany the detailed description can be briefly described as follows:

FIG. 1 shows a general schematic view of an example electrical power generating system.

FIG. 2 shows a schematic view of an overvoltage protection device of the FIG. 1 system.

FIG. 3 shows the flow of an example method for protection against overvoltage from a generator in the FIG. 1 system.

### DETAILED DESCRIPTION

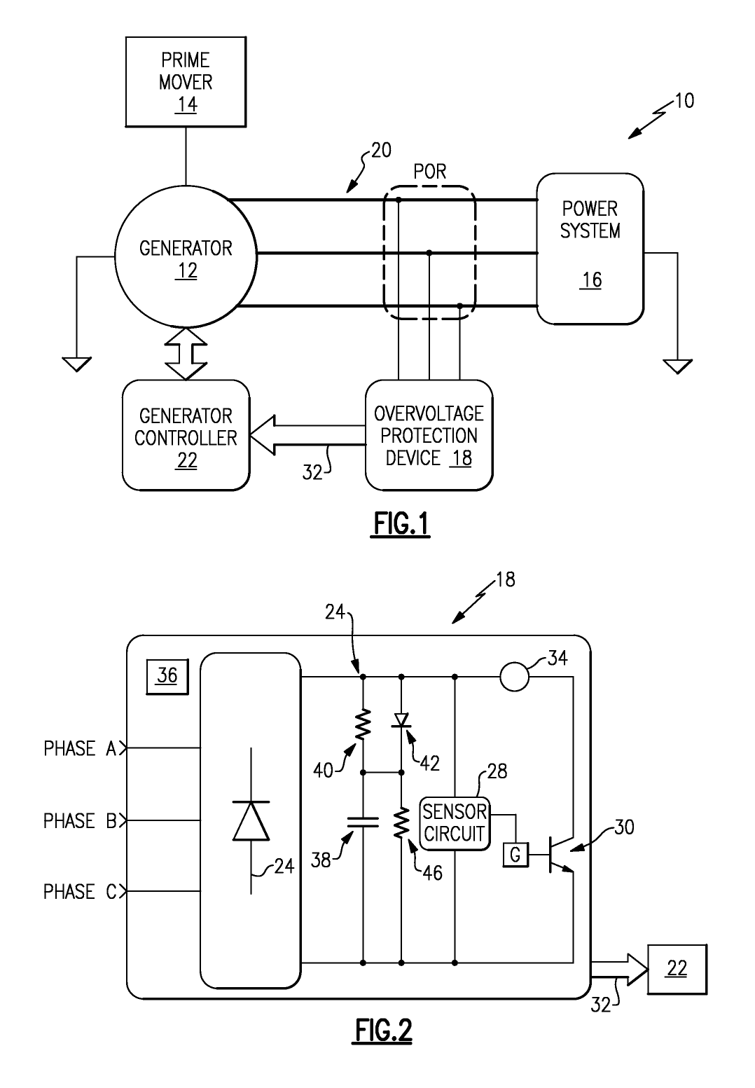

Referring to FIG. 1, an example electrical power generating system 10 includes a generator 12 driven by a prime mover 14, such as a gas turbine engine of an aircraft. Other example prime movers include diesel engines, a spark-ignited engine, a natural gas engine, a hybrid engine, or another variety of engine or turbine known in the art.

The generator 12 powers an AC electrical power system 16 or some other type of load. An overvoltage protection device 18 protects the AC electrical power system 16 from overvoltage events associated with power provided by the generator 12.

The example generator 12 is a variable frequency generator that provides a three-phase AC voltage along paths 20. The generator 12 is controlled by a generator controller 22. The generator controller 22 can adjust the generator 12 to produce a higher or a lower AC voltage. During an overvoltage event, a discrete signal may be communicated to the generator controller 22 to change the generator 12 to de-excite.

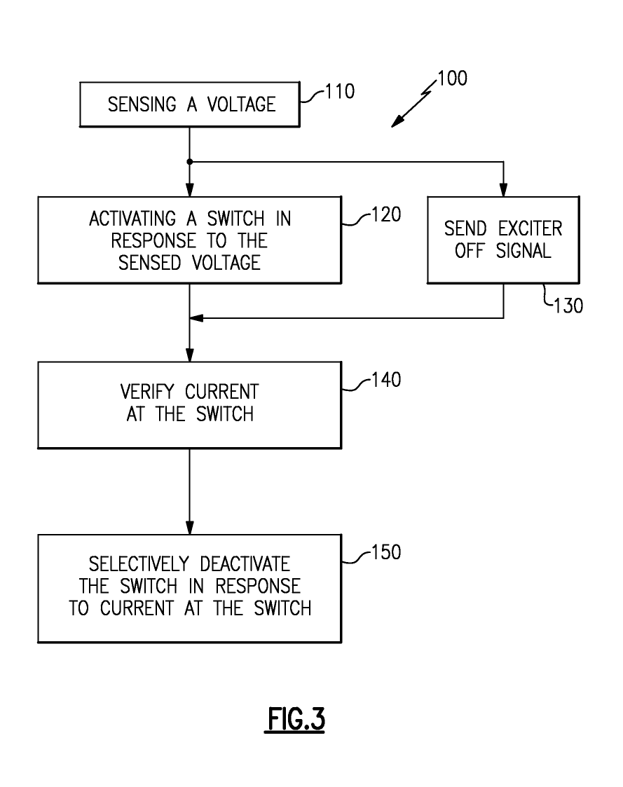

Referring now to FIG. 2 with continuing reference to FIG. 1, the paths 20 take the AC voltages (Phase A, Phase B, and Phase C) from the generator 12 to a DC bus 24. A rectifier bridge 26 rectifies the three-phase AC voltages and converts the AC voltage to a DC voltage on the DC bus 24. The example bus is a 235 volt AC bus.

In this example, a sensor circuit 28 is used to measure the DC voltage on the DC bus 24. The sensor circuit 28 is configured to selectively transition a switch 30 between an on-state and an off-state using a gate drive G. The switch 30 is a solid state switch such as a power semiconductor switch in this example.

The switch 30 provides a hard short to the generator 12. The switch 30 also may initiate an exciter off command, which tells the generator controller 22 to turn off a voltage regulator (not shown) of the generator 12.

The example sensor circuit 28 transitions the switch 30 to the on-state. For example, if the sensor circuit 28 detects the DC bus 24 voltage exceeding a threshold value, say 700 volts, the sensor circuit 28 transitions the switch 30 to the on-state to provide a hard sort to the generator and absorbs the (voltage) from the DC bus 24 in excess of 700 volts. In this example, a voltage exceeding 700 volts is considered an overvoltage condition because this voltage exceeds the threshold value. The example sensor circuit 28 maintains the switch 30 in the off-state when there is no overvoltage condition.

In the on-state, power flow will be interrupted. The switch 30 thus provides a hard short to the generator 12, which collapses the AC bus voltage. When the switch 30 is transitioned to the on-state, the overvoltage protection device 18 sends an Exciter Off signal to the generator control unit 22 to de-excite the generator 12. The Exciter Off signal moves along path 32.

The example overvoltage protection device 18 includes a DC link current sensor 34 that measures current through the switch 30. In this example, prior to transitioning the switch 30 from the on-state to the off-state, the DC link current sensor 34 verifies that there is no current moving through the switch 30. The example switch 30 is moved back to the off-state only after the verification.

A controller 36 of the overvoltage protection device 18 may be used to control movement of the switch 30 between the off-position and the on-position. The controller 36 receives the current information from the link current sensor 34 before initiating movement of the switch 30 from the on-state to the off-state, for example.

Moving the switch 30 from the on-state to the off-state prematurely may undesirably cause an overvoltage spike. In this example, the movement is premature if any current is moving through the switch 30. Other examples may determine that some small level of current moving through the switch 30 is acceptable.

The example link current sensor 34 is a DC link current sensor. A Hall effect sensor is used as the link current sensor 34 in one example.

The example overvoltage protection device 18 also includes a capacitor 38, a discharge resistor 40, a snubber diode 42, and a bleeder resistor 46. The capacitor 38 is used to filter voltage from the DC bus 24, which smoothes short-period voltage spikes by slowing the rate of change of the voltage. In one example, the capacitor 38 slows the rate of change as the voltage from the DC bus 24 moves from a typical voltage condition to an overvoltage condition. Slowing the rate of change of the voltage provides additional time for the switch 30 to be transitioned to the on-state, thus preventing the protection system from false triggering. The discharge resistor 40 facilitates discharge of energy from the capacitor 38 in a known manner.

In this example, the snubber diode 42 charges the capacitor 38 based on the peak line-to-line AC voltage. Also, the bleeder resistor 46 bleeds stored energy in the capacitor 38 when the overvoltage condition is over and the power system returns to normal.

Referring to FIG. 3, an example method 100 of accommodating an overvoltage includes sensing a voltage at step 110. The voltage is provided by a generator through a bus in this example. The method 100 then selectively activates a switch to activate a switch at a step 120. The switch is activated in response to the sensed voltage from the step 110. When the switch is activated, an Exciter Off signal is communicated to the generator control unit 22 at a step 130.

The method 100 then measures a current moving through the switch at a step 140. If the current is zero (or some other predetermined level), the method 100 deactivates the switch at a step 150. If the current not zero (or exceeds the predetermined level), the method 100 maintains the switch in an active position.

Features of the disclosed examples include protecting loads from an overvoltage condition due to an early decoupling of a surge protection device.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

I claim:

1. An overvoltage protection device, comprising:
a switch;
a DC link current sensor that measures current through the switch; and
a surge protection device that is selectively activated by transitioning the switch between an off-state and an on-state, wherein the switch is transitioned from the on-state to the off-state in response to a current reading from the DC link current sensor.

2. The overvoltage protection device of claim 1, wherein the switch is transitioned from the off-state to the on-state in response to a voltage.

3. The overvoltage protection device of claim 2, including a sensor circuit that determines the voltage by sensing the voltage from a bus.

4. The overvoltage protection device of claim 1, wherein the current reading is a zero current reading.

5. The overvoltage protection device of claim 1, wherein the surge protection device activated when the switch is in the on-state and deactivated when the switch is in the off-state.

6. The overvoltage protection device of claim 1, wherein the switch is transitioned from the off-state to the on-state when the voltage exceeds a threshold voltage.

7. The overvoltage protection device of claim 6, wherein the surge protection device is configured to absorb voltage in excess of the threshold voltage.

8. The overvoltage protection device of claim 1, wherein the link current sensor comprises a Hall effect sensor.

9. The overvoltage protection device of claim 1, wherein the current sensor comprises a DC link current sensor.

10. An electrical power system overvoltage protection arrangement, comprising:
a variable frequency generator that provides an AC voltage to a bus, the bus providing a DC voltage;
an overvoltage protection device that activates a surge protection device if the DC voltage exceeds a threshold value, the surge protection device configured to absorb the DC voltage in excess of the threshold value; and
a DC link current sensor that measures current, wherein the overvoltage protection device is deactivated in response to a current reading from the link current sensor.

11. The electrical power system overvoltage protection arrangement of claim 10, wherein the variable frequency generator is powered by a gas turbine engine.

12. The electrical power system overvoltage protection arrangement of claim 10, wherein the AC voltage is a three-phase AC voltage.

13. The electrical power system overvoltage protection arrangement of claim 10, wherein the link current sensor comprises a DC link current sensor.

14. The electrical power system overvoltage protection arrangement of claim 10, including a switch configured to selectively activate and deactivate the surge protection device in response to a variation of the DC voltage, the switch and the surge protection device connected in series across the DC bus, wherein the switch deactivates the overvoltage protection device in response to a current reading from the DC link current sensor.

15. The electrical power system overvoltage protection arrangement of claim 14, wherein the current reading is a zero current reading.

16. A method of accommodating an overvoltage, comprising:
sensing a voltage;
selectively activating a surge protection device in response to the sensed voltage; and
selectively deactivating the surge protection device in response to a current reading.

17. The method of claim 16, wherein the surge protection device is selectively activated by transitioning a switch between an on-state and an off-state, the surge protection device activated when the switch is in the on-state, the surge protection device deactivated when the switch in the off-state.

18. The method of claim 17, wherein the switch is transitioned to the on-state if the sensed voltage exceeds a threshold voltage, and the switch is transitioned to the off-state if the current reading through the switch is less than or equal to a threshold current.

19. The method of claim 18, wherein the threshold current is zero.

20. The method of claim 16, wherein a DC link current sensor provides the current reading.
